(19) United States
(12) Patent Application Publication
(10) Pub. No.: US 2007/0163733 A1
(43) Pub. Date: Jul. 19, 2007

(54) Collapsible paintball bunker

(75) Inventor: William Phillips, Rockaway, NJ (US)

Correspondence Address: WILLIAM PHILLIPS, 179-9 RT. 46, # 118, ROCKAWAY, NJ, 07866, US

(73) Assignee: William Phillips, Rockaway, NJ (US)

(21) Appl. No.: 11/306,866

(22) Filed: Jan. 13, 2006

(51) Int. Cl. A47G 5/00; E06B 9/24

(52) U.S. Cl. 160/351; 160/352

(57) ABSTRACT

A collapsible shaped structure to be used in paintball as a bunker having at least two loop members to use to stake to the ground for stability, to attach to additional shaped structures and also to secure the shape in the collapsed position. Each shape is comprised of a helically coiled rod supporting a covering, which is attached to the rod to define a shape. The first and second ends define endings or openings depending on the shape. Some shapes will be completely closed while other shapes will have one or more open ends. Shapes will be able to be collapsed flat to store and transport.

### BACKGROUND OF THE INVENTION

1. Field of the Invention

This invention relates to play structures for paintball fields, and in particular to collapsible bunkers to be used in paintball for which players can hide behind, crawl through and climb on. In their normal opened configurations, the structures define a plurality of bunkers. The structures may also be collapsed and folded into a compact configuration for easy transportation and storage.

2. Description of the Prior Art

Two important considerations for bunkers targeted for paintball players are convenience and variety. Relating to convenience, a bunker must be easily transportable so that the players can move it around the field, or even to other places such as a wooded area. A bunker must also be easily stored since a field, team or player is likely to have many other bunkers that compete for precious storage space. As for variety, a bunker must offer enough variety in play so that the players will be able to enjoy it for a long period of time without getting bored.

Larger bunkers often pose a greater problem with regards to convenience. The larger bunkers tend to be bulky, which makes it difficult to move them around the fields, and sometimes makes it prohibitive to move them around once they are set up. Bulky bunkers also take up much storage space. Inflatable bunkers require the use of blowers, fans and several other devices to operate. They are also heavy and prone to puncture resulting in higher maintenance costs.

In the past, attempts have been made to provide bunker structures for the use in paintball. Such bunker structures have been provided in many different shapes and sizes. For example, some have been shaped as playhouses to allow players to climb into and out of the structure. However, in order to provide a structure that can temporarily house a player, such a structure must be quite large and would be difficult to transport and store.

A type of play structure that has been popular with children is a play tunnel. These play tunnels provide a long passageway or tunnel through which a child can crawl. These play tunnels are normally made by wrapping a piece of fabric about a helically-shaped metal loop, with the loop defining the shape of the tunnel. Since the metal loop is helical, the tunnel may be collapsed into a smaller configuration by pressing both ends of the tunnel against each other, and then tying both ends together. Unfortunately, these play tunnels do not provide much variety or durability in the paintball field.

Thus, there remains a need for a collapsible bunker to be adapted to the sport of paintball. Shapes which may be adapted at the player's discretion to assume a plurality of different configurations for increased variety of play, and is convenient to use, to transport, and to store.

### SUMMARY OF THE DISCLOSURE

In order to accomplish the objects of the present invention, the collapsible bunker structure according to the present invention comprises at least two sets of loop members at opposite ends coupled to each other, each ending having a particular size and configuration. The bunker structure of this invention comprises a helically coiled rod supporting a covering which is attached to the rod to define a shape. The opposite ends of each shape adapted to be connected to one of the loop members of the connector on the other end. The ends of each shape can be connected to a corresponding loop member of another shape.

Each shape according to the present invention further comprises at least two tie members provided at the first end, the first end of each shape adapted to be compressed against the second end of that same shape, with the at least two tie members at the first end used to secure the particular shape in a compressed state against the loop connectors at the second end.

In a preferred embodiment according to this invention, the structure can be collapsed or reduced to a smaller size by first compressing the first end of each shape against its second end.

### BRIEF DESCRIPTION OF THE DRAWINGS

FIG. 1 is a perspective view of a collapsible bunker structure;

FIG. 2 is a perspective view of an internal wire that is used to define and support any of the collapsible bunkers of FIG. 1;

FIG. 3 is a cross-sectional view of a bunker of FIG. 1 taken along line 3--3 thereof;

FIG. 4 illustrates how the collapsible bunker structure of FIG. 1 may be collapsed and folded for compact storage;

FIG. 5 illustrates how the collapsible bunker structure of FIG. 1 may be held in the collapsed state;

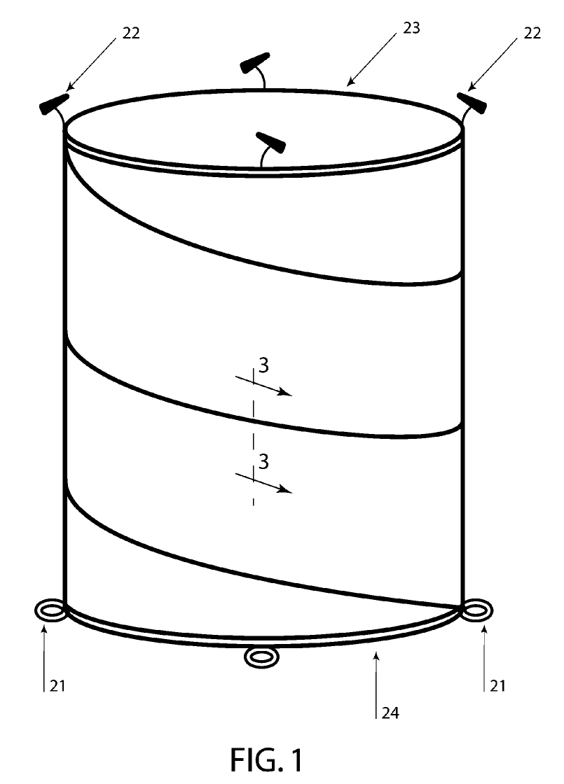

FIGS. 1, 6, 7, 8, 9, 10, 11 are perspective views of various shapes of collapsible bunker;

### DETAILED DESCRIPTION OF THE PREFERRED EMBODIMENTS

The following detailed description is of the best presently contemplated modes of carrying out the invention. This description is not to be taken in a limiting sense, but is made merely for the purpose of illustrating general principles of embodiments of the invention. The scope of the invention is best defined by the appended claims.

FIG. 1 shows the deployed bunker structure 1 of this invention.

FIGS. 6-11 show different, but not limited to, various shapes that can also be created.

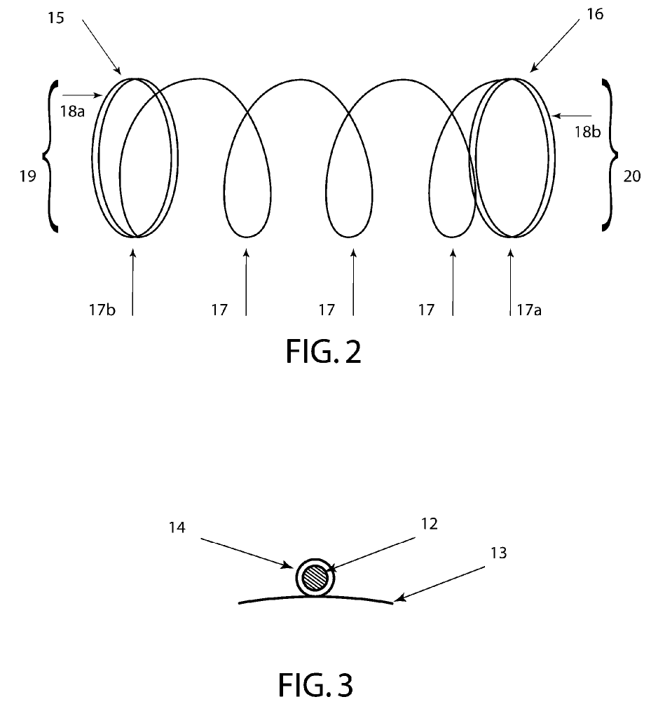

Each shape 1, 6, 7, 8, 9, 10 and 11 comprises an internal support rod 12 supporting a covering 13 which is attached to the rod 12 to define the bunker shape. The rod 12 is helically coiled, with the adjacent coils 17 being normally biased in spaced apart relation, as shown in FIG. 2. The rod 12 defines a first end 15 and a second end 16. At the first and second ends 15 and 16, the rod 12 extends past the outer coil 17a and 17b, respectively, so that a segment 18a and 18b at each end 15,16 of the rod 12 overlaps with the outer coil 17a and 17b, respectively.

The covering 13 is attached to the rod 12 by gluing, stitching, fusing, mechanically fastening or other conventional attachment methods. Alternatively, as shown in FIG. 3, a sleeve 14 may be stitched or otherwise provided along the covering 13 with the rod 12 housed or attached therein. The first end 16 of the rod 12 terminates at a first substantially coiled edge 23 of the covering 13. The outer coil 17a of the first end 16 forms a substantially coiled end rod portion 20 to provide support to the first edge 23 of the covering 13. Similarly, the second end 15 of the rod 12 terminates at a second substantially coiled edge 24 of the covering 13. The outer coil 17b of the second end 15 forms another substantially coiled end rod portion 19 to provide support to the second edge 24. The circular end rod portions 20 and 19 and their respective coiled edges 23 and 24 each defines an opening through which a player may crawl into or hide behind.

A first set of tie members 22 are provided in spaced-apart manner along the first edge 23, and a second set of tie members 21 are provided in spaced-apart manner along the second edge 24. Each tie member 22, 21 comprises of one loop and one toggle which can be clasped together. Each set of connecting members 22, 21 could comprise any number of loop and toggle members, but preferably comprises at least two loop and toggle members. In addition, each edge 23 and 24 preferably comprises two sets of loop and toggle members, although any number of sets of loop and toggle members can be utilized at each edge 23 and 24 without departing from the spirit and scope of the present invention.

The rod 12 is preferably made from a strong yet springy material, such as steel, but also can be made from other strong and coilable materials, such as fiberglass or plastic. Such materials are preferably capable of allowing the rod 12 to maintain its coiled shape. The covering 13 is preferably made from a strong durable fabric, such as cotton, canvas, mesh or net, but can also be made from other strong durable materials such as PVC or plastic. The term fabric is to be given its broadest meaning and should be made from strong, lightweight materials and may include woven fabrics, sheet fabrics or even films. The covering 13 should be water-resistant and durable to withstand the wear and tear associated with rough treatment by paintball players.

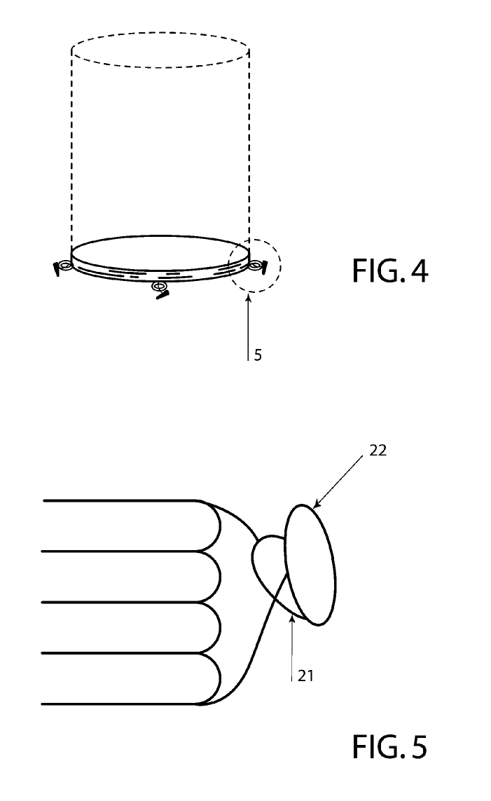

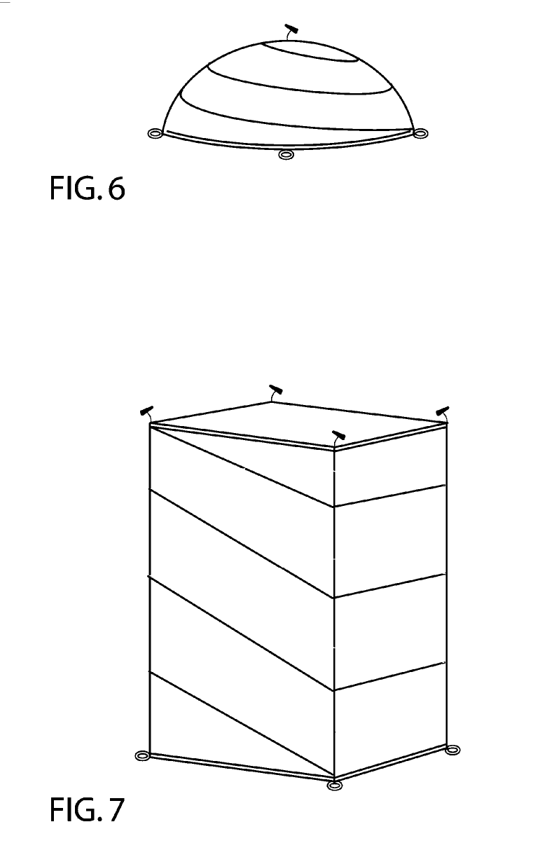

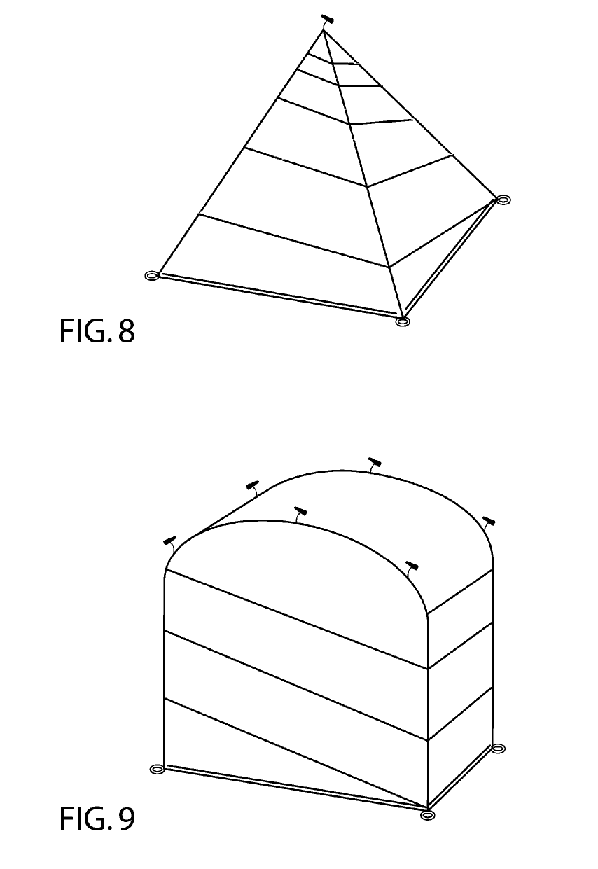

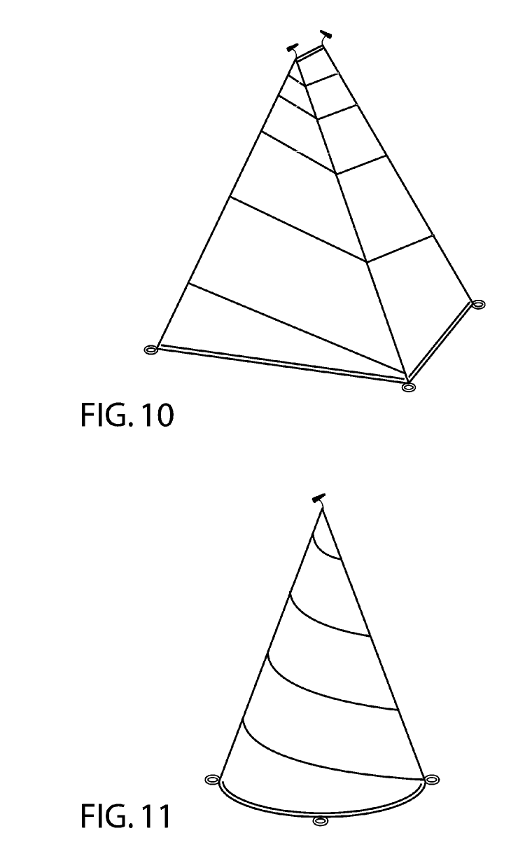

The collapsible bunker structure 1 can be easily collapsed and folded for storage. In the first step shown in FIG. 4, each of the bunkers 1, 6, 7, 8, 9, 10 and 11 are compressed against the opposite 15 and 16 ends. Specifically, to compress a bunker, for example, bunker 1, the user grips the circular end rod portion 20, or the first edge 23, of the bunker 1 with one hand, and while using the other hand to grip the corresponding loop member 24 and attached end rod portion 19, pushes or compresses the end rod portion 20 against the end rod portion 19. This compresses the plurality of helical coils of the rod 12 against each other. This compression is made possible by the springy nature of the rod 12, and its helically coiled configuration. With the rod 12 compressed, both ends of the toggle assembly 21 and 22 are locked together to keep the bunker compressed.

The dimensions of the end 15 are not critical, but must be large enough for a player to crawl through or hide behind. The dimensions will also depend on the type of player targeted. For example, a collapsible tunnel structure 1 targeted at pre-teens may be smaller than one that is targeted at adults

Further, the shapes of the bunker structure can be varied without departing from the spirit and scope of the present invention. For example, the toggle connectors 21 and 22 are not required to have only two loop and toggle members defining the round configuration shown in FIGS. 1 and 6-11, but may comprise two, three, five or even a greater number of loop and toggle members to define a triangular, rectangular, or other polygonal, geometric configuration. Similarly, the shapes 1, 6, 7, 8, 9, 10 and 11 not necessarily be substantially straight, as shown in FIGS. 1 and 6-11, but can assume other configurations such as an L-shaped, S-shaped, U-shaped, or other configurations. This can be accomplished by providing the internal support wire 12 in the desired configuration and then attaching the covering 13 to it to form the tunnel. Further, the length of the bunkers can be varied to form bunkers of different lengths and shapes. As a further example, the bunkers 1, 6, 7, 8, 9, 10 and 11 do not necessarily need to be substantially circular, but can assume a square, rectangular, triangular, polygonal or other shape. This can accomplished by coiling the internal support wire 12 to the desired shape and then attaching the covering 13 to it to form the tunnel. Moreover, any combination of modifications described hereinabove may be utilized to provide bunkers 1, 6, 7, 8, 9, 10 and 11 of varying shapes and sizes without departing from the spirit and scope of the present invention. Each bunker 1, 6, 7, 8, 9, 10 and 11 can also be provided with loop members of different shapes and sizes to facilitate use with tunnels of different shapes and sizes.

One example is illustrated in FIG. 6-11, in which a collapsible bunker structure having different shapes and sizes. Thus, for the collapsible tunnel structures according to the present invention, the separate bunkers 1, 6, 7, 8, 9, 10 and 11 may be provided or purchased on an individual basis so that a player or field may be able to create a bunker field structure of a desired shape and size. Alternatively, a specific number of different bunkers 1, 6, 7, 8, 9, 10 and 11 may be packaged and sold together. However, it will be appreciated that only one bunker 1 structure according to the present invention. In either case, the player or field will have the opportunity to create an endless variety of bunker structures at their disposal, thereby enhancing the amusement value of the bunker structures.

Further, the structure and configuration of the bunkers according to the present invention allow any resulting bunker structure to be easily folded and collapsed for transportation and storage.

While the description above refers to particular embodiments of the present invention, it will be understood that many modifications may be made without departing from the spirit thereof. The accompanying claims are intended to cover such modifications as would fall within the true scope and spirit of the present invention.

What is claimed is:

1. A collapsible shaped structure to be used in paintball as a bunker comprising: of shapes include tubes, tunnels, pyramids, spheres, houses, tombstones, rectangles, cubes, cones, wedges and any other geometric shape; and all shapes being internally supported by a coiled rod with a covering that is attached to the rod to define the shape; and a connector consisting of at least two loop members to be coupled to each other to keep the bunker in a collapsed position; and wherein on the deployment of the shape, the rod causes the fabric covering to become taught defining the shaped bunker.

2. The structure of claim 1, wherein each loop member of the connector is used to attach to the ground in order to stabilize the shape.

3. The structure of claim 2, wherein the connector further comprises an upper cover piece and a lower cover piece attached to the ends.

4. The structure of claim 2, wherein the first and second ends of each rod comprises an outer rod portion and an overlapping segment that overlaps the outer rod portion.

5. The structure of claim 2, wherein each end of the rod of each shape helically coiled.

6. The structure of claim 1, wherein each end of the connector has a shape that is different from the shape of the other ends.

7. A method of collapsing a collapsible shape structure comprising a connector having at least two loop members coupled to each other, each loop member defining an ending having a particular size and configuration, the collapsible shape structure comprises a coiled rod supporting a covering which is attached to the rod to define a shaped bunker. The first and second ends each having a size and configuration wherein the each end of each shape is connected to one of the loop members of the connector, the method comprising the steps of: (a) compressing the first end of each shape against its second end; (b) securing each compressed shape against its corresponding loop member.
